(19) United States
(12) Patent Application Publication
(10) Pub. No.: US 2013/0031816 A1
(43) Pub. Date: Feb. 7, 2013

(54) SIMULATED FLAME FIREPLACE

(71) Applicant: David Deng, Diamond Bar, CA (US)

(72) Inventor: David Deng, Diamond Bar, CA (US)

(21) Appl. No.: 13/298,240

(22) Filed: Nov. 16, 2011

(30) Foreign Application Priority Data
Aug. 3, 2011 (CN) 201110254888.8

(51) Int. Cl. G09F 19/02

(52) U.S. Cl. 40/428

(57) ABSTRACT

A simulated flame fireplace comprising a fireplace housing, a heating apparatus, and an apparatus that generates simulated flames. The apparatus that generates simulated flames comprises at least one movable member with a plurality of light sources attached to it. When the apparatus is active, the light sources are configured to vary in intensity as the at least one member moves such that the plurality of light sources generates an appearance of flames.

### CROSS-REFERENCE TO RELATED APPLICATIONS

This application is related to and claims priority to Chinese Patent Application No. 201110254888.8, filed on Aug. 3, 2011, the entire application of which is hereby incorporated by reference.

### FIELD OF THE DISCLOSURE

The present disclosure relates generally to fireplace systems, and more particularly to simulated flame fireplace systems.

### BACKGROUND

Fireplaces are a popular method of heating a home while providing an enjoyable environment. Unfortunately, traditional fireplaces have a number of disadvantages, including inefficiencies and high maintenance costs. Fireplace systems can serve as clean, cheap, and easy alternatives to traditional fireplaces. While some fireplace systems have real flames, varieties exist that rely on simulated flames.

New areas exist in which to improve these fireplace systems with simulated flames.

### SUMMARY OF THE DISCLOSURE

A simulated flame fireplace according to certain embodiments includes at least one movable member and a plurality of light sources attached to the at least one movable member, each light source configured to vary in intensity as the at least one movable member moves such that the plurality of light sources generates an appearance of flames.

In some embodiments, the simulated flame fireplace further includes a heating apparatus. Additionally, the simulated flame fireplace may include an outer housing, such as a mantel, and at least one air passage to direct a flow of air heated by the heating apparatus.

In certain embodiments, a simulated flame fireplace comprises a plurality of exterior surfaces that combine to form an interior space and a plurality of interior surfaces connected to the exterior surfaces to define at least one airflow path. The fireplace further comprises a heating apparatus configured to convey ambient air into the at least one airflow path, heat the ambient air, and expel the heated air from the airflow path. The fireplace further comprises at least one movable member within the interior space and a plurality of light sources attached to the at least one movable member, each light source configured to vary in intensity as the at least one movable member moves such that the plurality of light sources generates an appearance of flames.

In certain embodiments, a simulated fireplace comprises a housing comprising a base, a back, a top, a left side, and a right side, wherein the base, the top, and the sides extend forward from the back, creating a space. The fireplace further comprises at least one airflow passage attached to the fireplace housing in a position located forward from the back, each airflow passage containing at least one air inlet, at least one air outlet, and at least one heating element. The fireplace further comprises at least one fan configured to direct air through the at least one air inlet into the at least one airflow passage, whereby the air passes in proximity to the heating element and exits the airflow passage through the at least one air outlet. The fireplace further comprises at least one movable member within the interior space and a plurality of light sources attached to the at least one movable member, each light source configured to vary in intensity as the at least one movable member moves such that the plurality of light sources generates an appearance of flames.

In certain embodiments, a simulated flame fireplace comprises a housing defining an interior space and a heating apparatus configured to expel heated air from the housing. The fireplace further comprises at least one movable member within the interior space and a plurality of light sources attached to the at least one movable member, each light source configured to vary in intensity as the at least one movable member moves such that the plurality of light sources generates an appearance of flames.

### BRIEF DESCRIPTION OF THE DRAWINGS

FIG. 1 is a perspective view of one embodiment of the simulated flame fireplace with a plurality of rotatable blades visible.

FIG. 2 is a perspective view of the simulated flame fireplace of FIG. 1 with a schematic of how a viewer could see the simulated flame when active.

FIG. 3A is a front view of one embodiment of the simulated flame fireplace.

FIG. 3B is a top view of the simulated flame fireplace of FIG. 3A, taken along the line 3B-3B of FIG. 3A, with various elements removed for clarity.

FIG. 3C is the same view as FIG. 3B, but with a blocking portion retracted.

FIG. 4 is a perspective view of another embodiment of the simulated flame fireplace with a plurality of rotatable blades visible.

FIG. 5 is a front view of the simulated flame fireplace of FIG. 1 with a plurality of rotatable blades visible.

FIG. 6 is a front view of the simulated flame fireplace of FIG. 5 with a schematic of how a viewer could see the simulated flame when active.

FIG. 7 is a cross-sectional view of the simulated flame fireplace of FIG. 5, taken along the line 7-7 of FIG. 5.

FIG. 8 is a front view of a plurality of rotatable blades.

FIG. 9A is a schematic of simulated flames.

FIG. 9B is a schematic of simulated flames.

FIG. 9C is a schematic of simulated flames.

FIG. 10 is a block diagram of one embodiment of the control of the simulated flame fireplace.

### DETAILED DESCRIPTION OF CERTAIN EXEMPLIFYING EMBODIMENTS

A simulated flame fireplace can be used to generate warmth and create an appearance of flame without the difficulty of an actual fire. Simulated flame fireplaces desirably comprise a fireplace housing, a heating apparatus, and an apparatus that generates simulated flames.

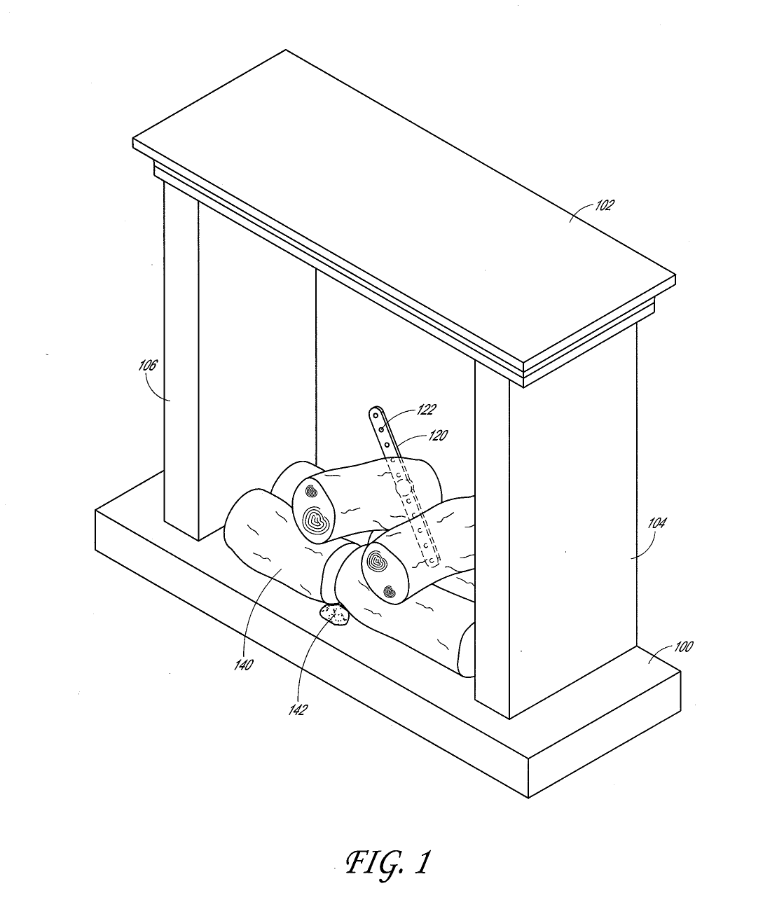

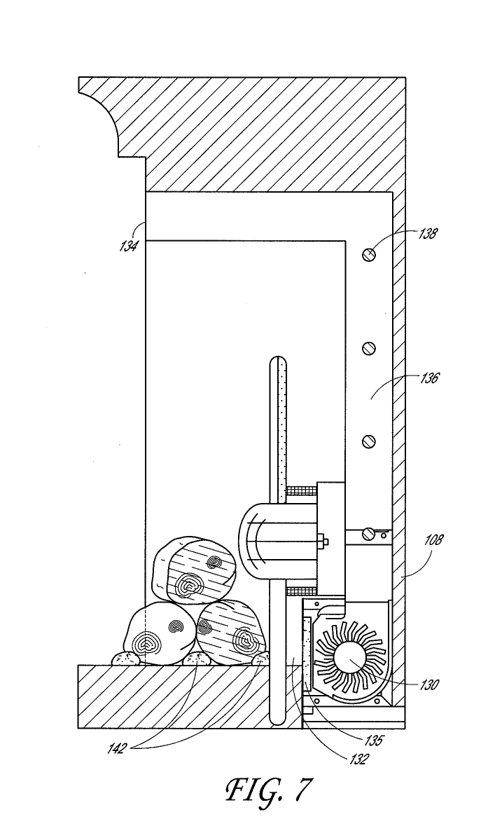

FIG. 1 illustrates one embodiment of a simulated flame fireplace. The fireplace housing desirably has a base 100, a top portion 102, a right side portion 104, and a left side portion 106. The fireplace housing can also have a back portion 108, visible in FIG. 7. The portions of the fireplace housing join to form an interior space. In some embodiments, there may be more or fewer portions that combine to form the interior space.

The simulated flame fireplace can also comprise elements found in a standard fireplace. For example, the embodiment present in FIG. 1 has false logs 140, which can make the simulated flame fireplace appear more realistic. Other elements found in a standard fireplace, such as an elevated log stand or grating, can be added to the simulated flame fireplace to increase the sense of realism. Artificial embers 142 can be placed below or among the logs, and lights can be used to illuminate all or a portion of the embers. The simulated flame fireplace can also comprise audio emission devices, which can be configured to output sounds associated with a true fire. It will be understood that the simulated flame fireplace can include more or less than these features. For example, a simulated flame fireplace may or may not include a mantle, a housing, or a heating apparatus.

As seen in FIG. 1, the apparatus that generates simulated flames can comprise a plurality of rotatable blades 120 with a plurality of light sources 122. As used throughout this disclosure, the term rotatable blades and the term blades are analogous and refer generally to any member or members configured to rotate about an axis. Thus the term could include a flat, curved surface similar to an actual fan blade, but it could also include tubular members, members with angular portions along their perimeters, members with widths that vary significantly along their lengths, discs, or any other shape configured to rotate about an axis. Rotatable blades can also refer to members of varying stiffness and members made from materials of varying flexibility. Further, while the term rotatable blades suggests more than one blade, the term should be understood to encompasses embodiments having a single member configured to rotate about an axis. Thus, a discussion of the placement of a set of blades should be understood to include the possibility that a single member could be placed as discussed. Additionally, the apparatus that generates simulated flames is not limited to using rotatable members. While rotatable members constitute a preferred embodiment and the embodiments described herein use rotatable blades, it is understood that the apparatus that generates simulated flames can comprise any type of movable member or members and is not limited to rotatable members.

With continuing reference to FIG. 1, when the blades 120 rotate some of the light sources independently 122 vary in intensity, which can include turning on and turning off, flickering, etc., in such a manner as to produce an appearance of flames. FIG. 1 is an image of the rotatable blades 120 as they rotate, captured in a moment in time such that the rotatable blades can be distinguished. Further, some embodiments can have substantially translucent blades so that they distract less from the sense of realism.

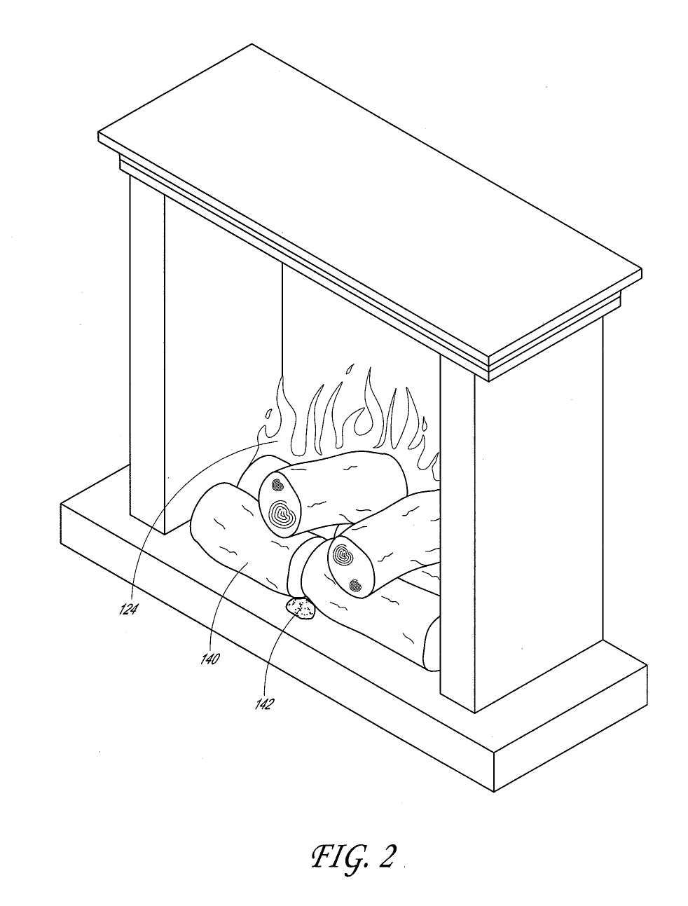

FIG. 2 illustrates a schematic view of the embodiment of FIG. 1 as it could appear to the eye/mind of a viewer when the rotatable blades and the plurality of light sources are activated. An image of flames 124 can be seen behind the false logs 140. When the blades 120 are not activated they are desirably generally positioned so that they are not easily visible by one sitting and/or standing in front of the fireplace, such as by being positioned behind the false logs 140.

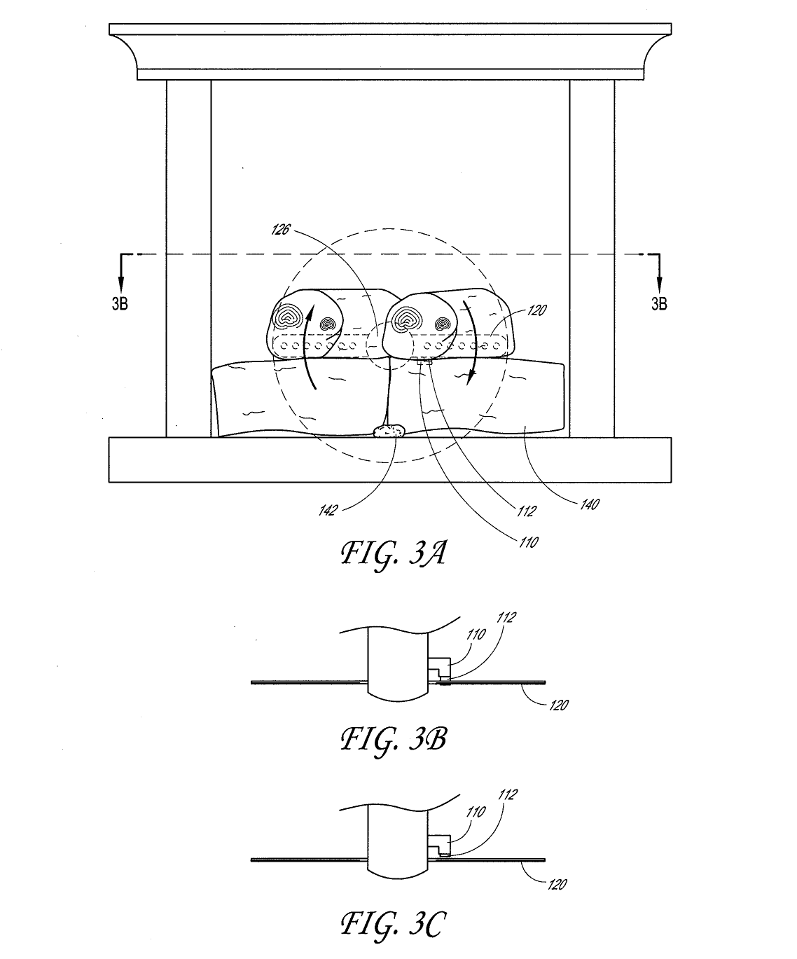

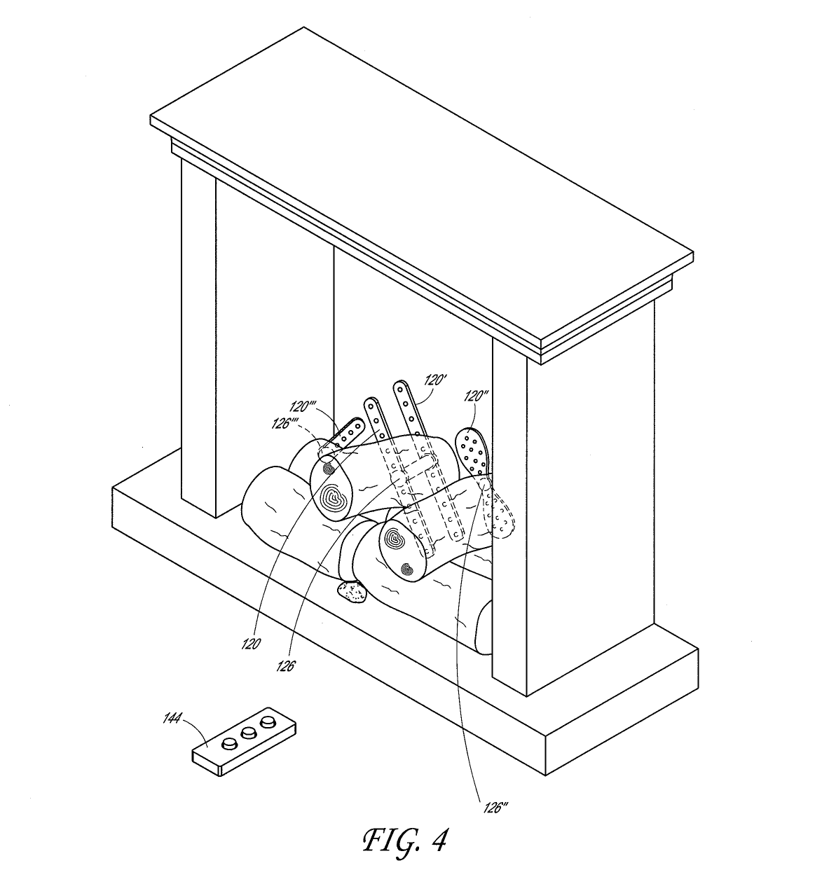

FIGS. 3A-3C illustrate one embodiment of the simulated flame fireplace with a mechanism for maintaining inactive rotatable blades 120 in a position that is not easily visible from one sitting and/or standing in front of the fireplace. FIG. 3A is a front view of the simulated flame fireplace with the rotatable blades inactive. FIGS. 3B and 3C are top-down views of the simulated flame fireplace of FIG. 3A, taken along the line 3B-3B, with the fireplace housing and other fireplace elements removed for clarity. The illustrated embodiment comprises an actuating device 110 and a blocking portion 112.

As illustrated in FIG. 3B, the blocking portion 112 when actuated extends into the plane of rotation and prevents rotation of the rotatable blades 120. In some embodiments, the blocking portion 112 need not extend into the plane of rotation but can move into the plane of rotation by rotation or some other means. The timing of actuation can be adjusted relative to when the blades are turned off such that they have time to naturally slow down before contacting the blocking portion. This delay can allow for less stress on the blocking portion and the rotatable blades upon contact. The blocking portion can also have padding and/or other mechanisms to minimize the stress and sound of contact. In addition, the blocking portion can maintain inactive rotatable blades 120 in other ways, such as securing one or more sides of the rotatable blades 120, engaging a hole or slot on the rotatable blades 120, engaging the axis 126, etc. When the rotatable blades are activated again and begin to rotate, the blocking portion 112 retracts to allow free rotation of the rotatable blades 120, as illustrated in FIG. 3C. In some embodiments, the blocking portion can be configured to block the rotatable blades even if they are activated.

The actuating device 110 can comprise a motor, a solenoid, or any other device capable of activating upon receipt of an electronic signal or current.

The actuating device 110 and blocking portion 112 are positioned relative to the rotatable blades 120 such that the blades are in a desired position when they hit the blocking portion and stop rotating. In FIG. 3A, for example, the blades are configured to rotate clockwise and the actuating device 110 and blocking portion 112 are located such that when the blades hit the blocking portion they will be substantially hidden from view by the logs 140. As shown, the rotatable blades 120 are in a substantially horizontal position. In other embodiments the actuating device and blocking portion can be positioned in different locations, depending on the placement of fireplace elements, such as false logs and embers, and on the rotational direction of the blades. The rotatable blades 120 can also be positioned in different orientations to be substantially hidden from view, including diagonal, and even vertical, depending on various factors such as those discussed above.

As illustrated in FIG. 4, some embodiments of the simulated flame fireplace can have multiple sets of rotatable blades. The sets of blades can be coaxial and positioned in separate, parallel planes, or can rotate about substantially collinear axes and be positioned in separate, parallel planes. For example, one set of rotatable blades 120 and another set of rotatable blades 120′ can rotate about the same axis 126, but they rotate in separate, parallel planes. Positioning sets of blades in multiple, parallel planes can help create a simulated flame with depth.

Additionally or alternatively, multiple sets of blades can rotate about axes that are not substantially collinear, so as to create multiple sets of simulated flame. For example, one or more sets of blades 120″ can generate a small flame around an axis 126″ to one side of the fireplace housing, while another set 120 or additional sets of blades can generate a larger flame around an axis 126 toward the center of the fireplace housing. Further, some embodiments can have a set of blades 120′″ that rotate about an axis 126′″ that is not substantially parallel to a second axis 126 about which rotates a second set of blades 120.

FIG. 4 further illustrates how a set of blades can comprise just a single blade 120′″, how a set of blades 120 can be longer than another set of blades 120′″, and how one set of blades 120 can be of a different shape than another set of blades 120″.

The blades need not be able to rotate a full 360 degree about the axis. For example, in some embodiments one or more sets of blades can rotate back and forth similar to a windshield wiper: from a first angle relative to a surface of the fireplace housing, to a second angle relative to the surface of the fireplace housing, back to the first angle relative to the surface of the fireplace housing, and then repeating. In these embodiments it is preferred, but is not required, to use a lighter, more flexible blade material and a blade structure that is less stiff than blades configured to rotate a full 360 degrees.

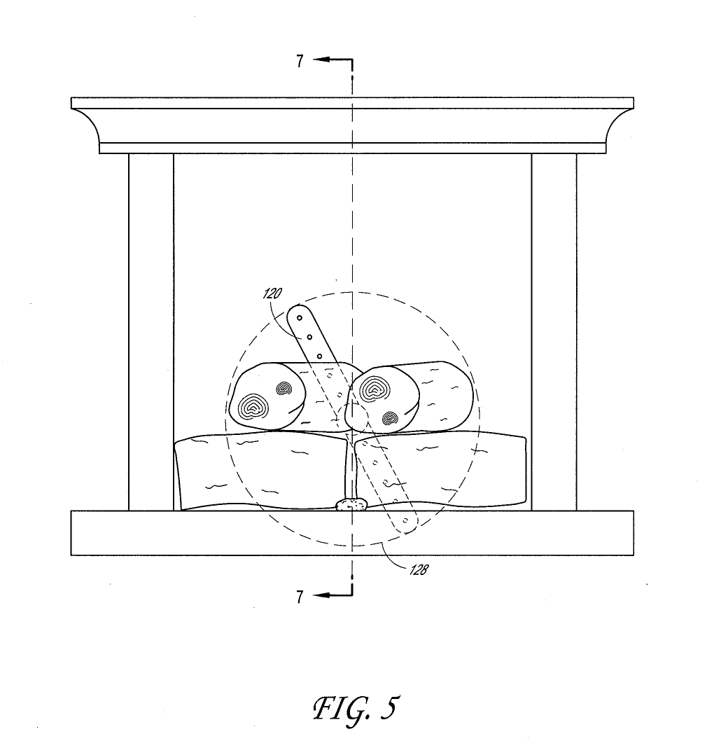

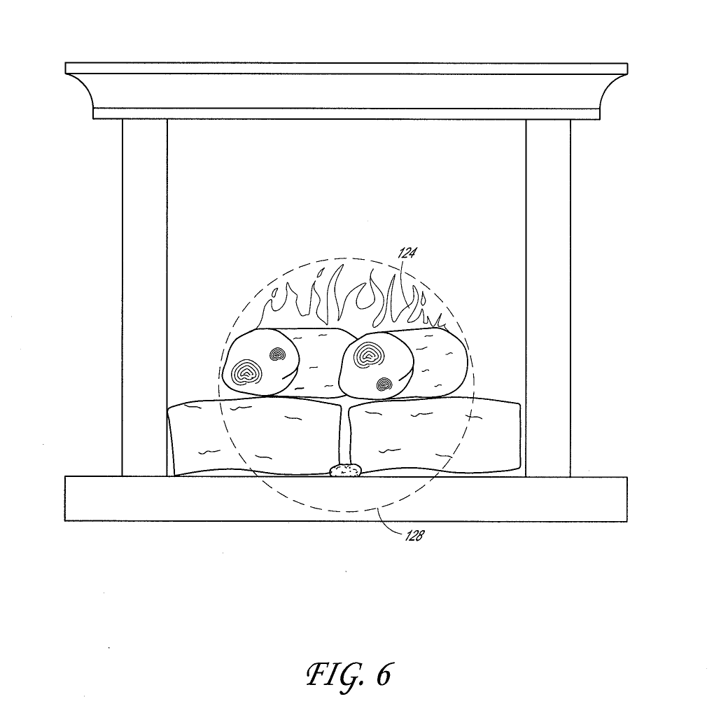

FIGS. 5 and 6 illustrate front views of one embodiment of the simulated flame fireplace. FIG. 5 is an image of the simulated flame fireplace when active, captured in a moment in time such that the rotatable blades 120 can be distinguished. FIG. 6 is the same embodiment as FIG. 5, but shown schematically as it would appear to the eye/mind of a viewer as the blades rotate. Instead of being able to discern individual blades, the viewer sees simulated flames.

As illustrated by FIGS. 5 and 6, the single rotatable blade 120 traces out a path 128. The area of the path 128 traced out by the rotatable blade 120 defines the maximum size of the simulated flames. In various embodiments, multiple blades can be sized and positioned such that each of the paths 128 are larger or smaller so as to define larger or smaller areas of simulated flames. It will be appreciated that the areas of simulated flames may overlap to create many sizes and shapes of composite simulated flames. Additionally or alternatively, the path 128 can be positioned relative to any fireplace elements, such as false logs 140, in such a manner that only a desired area of the path 128 is visible while the rest of the area of the path is blocked from view by the fireplace elements. In addition, simulated flames may also be seen between fireplace elements, such as between cracks in the false logs 140 or through the embers 142.

In some embodiments, as illustrated by FIG. 6, the timing of when individual lights among the plurality of light sources vary in intensity, which can include turning on and turning off, flickering, etc., can be configured such that the image of simulated flames 124 does not always extend to the full area traced out by the path 128. For example, if a user wanted a flame smaller than the area traced out by the path, in some embodiments the user can select a program whereby the light sources on the distal ends of the blades do not turn on. Alternatively, some embodiments may allow the user to select a program whereby the light sources on the distal ends of the blades turn on but only infrequently, creating a simulated flame where the outer reaches of the flame only infrequently extend to the path 128. Thus, while the area traced out by the path 128 defines the maximum size of the simulated flame 124, the simulated flame can vary in size and shape within that outer boundary.

FIG. 7 illustrates a cross-sectional view of the simulated flame fireplace. In this embodiment, the heating apparatus comprises a fan 130, an air inlet 132, an air outlet 134, an airflow passage 136, and one or more heating elements 138. The fan 130 draws or blows air into the airflow passage 136 through the air inlet 132, and the air passes through the airflow passage 136, exiting through the air outlet 134. The air inlet 132 can have a filter 135 to protect the heating elements and to keep the airflow passage clean. The filter 135 also serves to make sure that the air that ultimately exits the airflow passage is clean.

The heating elements 138 warm the air as it passes through, such that the air exiting through the air outlet 134 is warmer than the air entering through the air inlet 132. However, in some embodiments the fan can be active while the heating elements are not, in which case the air exiting through the air outlet 134 might not be warmer than the air entering through the air inlet 132. In other embodiments, the fan can be inactive while the heating elements are active, or the simulated flame fireplace may not have a fan at all, and the heating elements rely on natural convection to generate airflow.

In some embodiments, the fan 130 can be located in different locations relative to the airflow passage 136. For example, the fan can be located outside of the airflow passage 136 so long as it directs air into the airflow passage through the air inlet 132 and out of the airflow passage through the air outlet 134. Other embodiments can have multiple fans that direct air through the airflow passage 136; some, all, or none of the fans can be located inside the airflow passage and the remaining fans can be located outside the airflow passage. Generally, the fan or fans can be positioned anywhere so long as the fan or fans maintain fluid communication with the airflow passage.

Some embodiments may comprise multiple airflow passages, each of which can contain the above-discussed fan configurations.

With continuing reference to FIG. 7, the airflow passage contains a configuration of heating elements 138. The heating elements can be electrical, infrared, can operate on propane, natural gas, hot water, etc. or can have dual fuel capabilities such that they can operate on either propane or natural gas. When the fans and heating elements are active, the heating elements will heat the air that passes through the airflow passage 136. In some embodiments, the heating elements are adjustably controlled so as to operate at variable power outputs. This allows the user to control the temperature of the air that exits the airflow passage 136 through the air outlet 134.

In some embodiments, the heating elements 138 generate more heat than is received by the air passing through the airflow passage 136. The excess heat and the warmed air passing through can heat the surfaces of the airflow passage. In further embodiments, depending on the design of the fireplace housing and the shape of the rotatable blades, when the blades rotate they can generate a measurable airflow that exits the fireplace housing. This airflow shall be denominated blade airflow. In embodiments where the surfaces of the airflow passage have heated, the rotatable blades can be configured such that any blade airflow can include air originating from a location proximal to the airflow passage. This air will have received heat from the surfaces of the airflow passage, so the blade airflow will be at a higher temperature than air outside of the fireplace housing.

In embodiments where the heating elements are not active, the blade airflow can have a cooling effect, similar to the airflow generated by a fan. It will also be understood that the rotatable blades can be configured to generate little to no air flow.

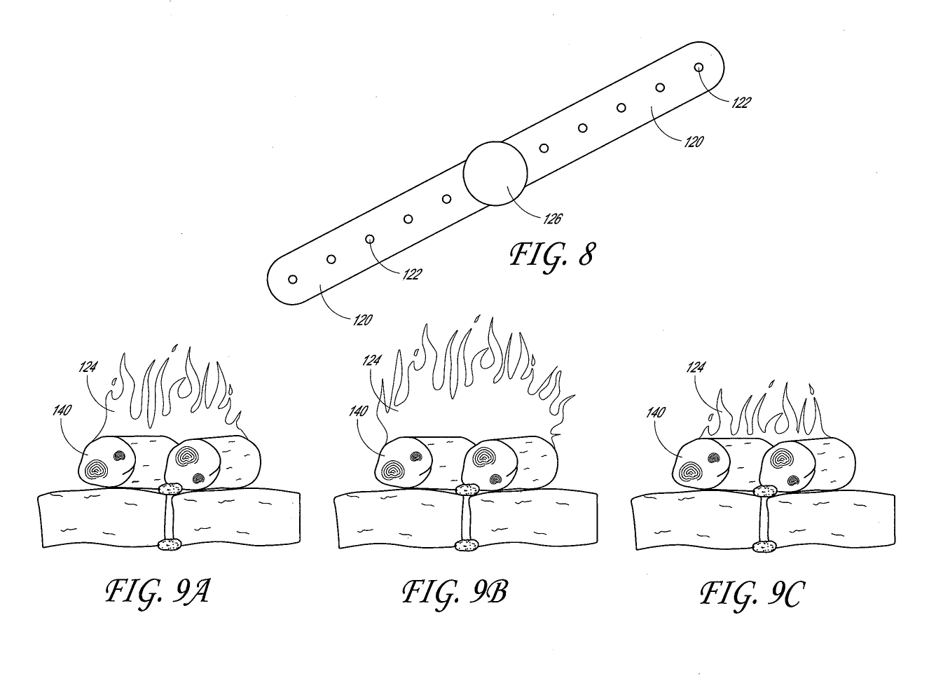

FIG. 8 illustrates one embodiment of a plurality of rotatable blades 120 and a plurality of light sources 122. In some embodiments, there can be just one rotatable blade. In other embodiments, there can be more than two rotatable blades, all rotating about a common axis 126 but in the same plane. Alternatively, some embodiments have multiple rotatable blades rotating about a common axis, but some of the blades rotate about the common axis in a different plane. In further embodiments, the plurality of rotatable blades can comprise multiple sets of rotatable blades, some of which are configured to rotate about different axes. The different axes can be parallel or nonparallel. In embodiments with more than one blade, the blades can be the same size or different sizes, and can be the same shape or different shapes.

In some embodiments, the blades can be completely or at least substantially translucent to help maintain the illusion of true flame. In some embodiments with multiple sets of rotatable blades operating in parallel planes, substantially translucent blades allow the viewer to better see the multiple layers of simulated flame. Additionally, while still being substantially translucent, in some embodiments the blades are tinted similar to colors from a fire so that light filtering through will be seen as having the same colors as an actual flame. The tinting can be a solid color, multiple solid colors, or a continuum of coloring. For example, the blades can be tinted blue at an end proximal to the axis of rotation and then gradually shift to a red or yellow at a distal end. In some embodiments, some of the blades can be one or more color without any translucency, while other blades may be translucent and/or tinted. Other configurations may also be used.

With continuing reference to FIG. 8, the plurality of rotatable blades 120 have a plurality of light sources 122 attached to the front surface of the blades. In some embodiments, including where the shape of the blade does not have a large enough front surface to mount the light sources or where the blade is cylindrically shaped and has a curved front surface, the light sources can be attached to available surfaces of the blade in locations such that the light can be visible to a viewer of the simulated flame fireplace. In some embodiments, at least some of the light sources themselves are not visible to the viewer but rather only the reflection of the light sources off of, for example, one or more internal surfaces of the fireplace housing. In some embodiments the light sources are light emitting diodes, although other embodiments can have other types of light sources.

The light sources need not be analogously placed across different blades. In some embodiments, a first blade can have more light sources than a second blade, or can have the light sources arranged in a different configuration than the second blade. While the light sources of FIG. 8 are in a single row and linearly spaced along the blade, other embodiments may have multiple rows of light sources, light sources that are not linearly spaced, or both multiple rows and nonlinearly spaced light sources. Further, some embodiments can have light sources of varying color and intensity on a single blade, or light sources of varying color and intensity on different blades.

As the blades rotate, each individual light source can vary in intensity, such as turning on and off, or flickering, according to a selected program. The result for a viewer watching the blades rotate can be a constantly changing image that approximates flame, as illustrated in FIGS. 9A-9C. The simulated flames 124 can vary in size and shape over time, much like a real flame, depending on the individual lights that are turned on in a given instant. Different embodiments can have different flame progressions: some may simulate a small fire with minimal variation in flame height and shape, while others may simulate larger fires with larger variations in flame height and shape.

In some embodiments, the user can select from among a group of programmed simulated flame progressions. In some embodiments, the activity of the heating apparatus coordinates with the programmed simulated flame progressions. For example, a programmed simulated flame progression may start out with a small fire and the heating apparatus powered such that the air exiting the air outlet exits at a lower temperature or at a lower power output relative to the maximum output capacity of the heating apparatus. Later, the fire can build and the temperature or output power of the air exiting the air outlet rises too. Alternatively, programs can exist for users that desire large simulated flames but low power output from the heating apparatus, or for users that desire small simulated flames but high power output from the heating apparatus. Thus, the simulated flame and the heat output may or may not be coordinated to provide corresponding levels of simulated flame and heat.

In other embodiments, the user can select a desired temperature or power output from the heating apparatus, and the simulated flames can be correspondingly large or small. In further embodiments, the user can select a desired length of time for the fire and the heating apparatus and/or simulated flames will automatically deactivate at the expiration of the desired length of time. In embodiments with a blocking portion such as the embodiments illustrated by FIGS. 3A-C, the simulated flame apparatus can be configured such that when the simulated flames deactivate, the blocking portion 112 extends to stop rotation of the blades 120 when they are in a desired position. When the user then activates the simulated flames again, the blocking portion 112 retracts to allow for rotation of the blades 120. In some embodiments the user can select an option whereby the blocking portion does not extend even when the blades are not rotating. The blocking portion can be set to extend after a set time period from when the simulated flames deactivate, or when the user turns off the simulated flame fireplace. For example, the blocking portion can be set to extend after about 5, 10, 15, 20, or 30 seconds after the simulated flame fireplace is turned off. In some embodiments, the blocking portion can extend at the same time or at substantially the same time as the simulated flame fireplace is turned off.

In some embodiments, when the user activates the simulated flame fireplace, both the heating apparatus and the rotatable blades activate, such that the simulated flame fireplace concurrently produces heat and simulated flames. In other embodiments, a user can activate the heating apparatus independently from the generation of simulated flames. Similarly, if a user desires to see the simulated flames without any heat, some embodiments allow the user to activate the generation of simulated flames without activating the heating apparatus.

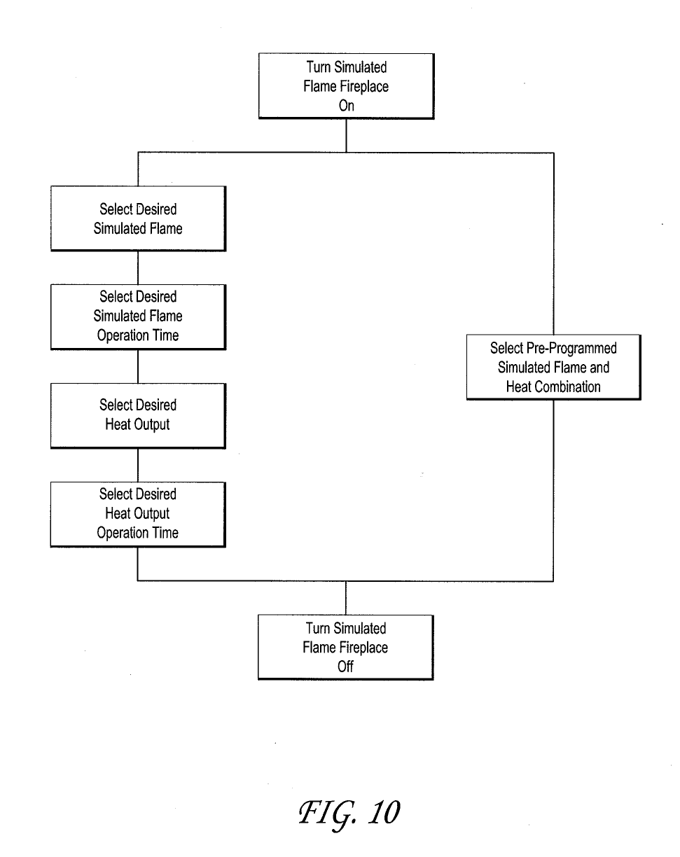

FIG. 10 illustrates a flow chart representing one embodiment of a control system for a simulated flame fireplace. When the user turns on the simulated flame fireplace the user has the option to select from pre-programmed simulated flame and heat combinations. The programs can include the combinations described above or other heat and simulated flame combinations. The programs can also be for varying amounts of time. Alternatively, the user can individually select the desired type of simulated flame and the operation time, wherein selecting the desired type of flame can include selecting the rotatable blades that will activate and the settings for their light sources. The user can then individually select the desired heat output and operation time. It is understood that the order of steps described in FIG. 10 can be varied, and that additional steps may be included or some of the steps listed in FIG. 10 may be excluded.

In some embodiments, the user can control and program the simulated flame fireplace with a controller 144, illustrated in FIG. 4. The controller 144 can be a remote control, a control unit electrically connected to the simulated flame fireplace, a thermostat, etc. In some embodiments, the user controls and programs the simulated flame fireplace directly.

Returning now to FIGS. 9A-C, a simulated flame fireplace is shown. The simulated flame fireplace can include a plurality of rotatable blades and a plurality of light sources attached to the rotatable blades, each light source configured to vary in intensity as the rotatable blades rotate such that the plurality of light sources generates an appearance of flames. The illustrated simulated flame fireplace may or may not include a heating apparatus. The simulated flame fireplace is shown without a mantel or outer enclosure. The illustrated simulated flame fireplace can be placed within a firebox of a wood burning fireplace to be used instead of wood or other combustibles. The simulated flame fireplace can also be used merely to give the appearance of a fire without generating heat. It will be understood that the simulated flame fireplace can also be used in other situations and placements. For example, the simulated flame fireplace can be placed in a fire pit, on the ground, on the floor, etc. The simulated flame fireplace can be used wherever it is desired to provide simulated flames and/or heat, if the simulated flame fireplace includes a heating apparatus.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

Similarly, this method of disclosure is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A simulated flame fireplace comprising:
a fireplace housing comprising a plurality of exterior surfaces that combine to form an interior space;
a plurality of interior surfaces connected to the plurality of exterior surfaces, defining at least one airflow path;
a heating apparatus configured to convey ambient air into said at least one airflow path, heat the ambient air, and expel the heated air from the airflow path;
at least one movable member within said interior space; and
a plurality of light sources attached to said movable member, each light source configured to vary in intensity as the at least one member moves such that the plurality of light sources generates an appearance of flames.

2. A method for controlling the simulated flame fireplace of claim 1, the method comprising:
turning on the simulated flame fireplace;
selecting the desired simulated flame;
selecting the desired operation time for the simulated flame;
selecting the desired heat output; and
selecting the desired operation time for the heat output.

3. The simulated flame fireplace of claim 1, wherein the movable member is a rotatable member.

4. The simulated flame fireplace of claim 3, further comprising a plurality of rotatable members and a plurality of axes, each axis serving as the axis of rotation for at least one rotatable member.

5. The simulated fireplace of claim 4, wherein at least two axes are not substantially parallel to each other.

6. The simulated flame fireplace of claim 1, wherein the plurality of light sources is a plurality of light emitting diodes.

7. The simulated flame fireplace of claim 1, wherein at least some of the plurality of light sources vary in intensity by turning on and off.

8. The simulated flame fireplace of claim 1, wherein the at least one movable member comprises at least one disc.

9. The simulated flame fireplace of claim 1, further comprising a plurality of movable members, at least two of which are of a substantially different size from each other.

10. The simulated flame fireplace of claim 1, further comprising a plurality of movable members, at least two of which are of a substantially different shape from each other.

11. The simulated flame fireplace of claim 1, wherein said one or more movable members and said plurality of light sources can be activated independently of said heating apparatus.

12. The simulated flame fireplace of claim 1, wherein said one or more movable members and said plurality of light sources can be configured to increase or decrease the size of the simulated flames in accordance with whether said heating apparatus is configured to output increasing or decreasing amounts of heat.

13. The simulated flame fireplace of claim 1, further comprising an actuator and blocking portion, wherein the actuator is configured to position the blocking portion so as to contact said at least one movable member and prevent further motion of said at least one movable member.

14. The simulated flame fireplace of claim 13, wherein the blocking portion is configured to prevent further motion of said at least one movable member when said at least one movable member has been deactivated.

15. A simulated flame fireplace comprising:
a fireplace housing comprising a base, a back portion, a top portion, a left side portion, and a right side portion, wherein the base, the top portion, and the side portions extend forward from the back portion, creating a space;
at least one airflow passage attached to the fireplace housing in a position located forward from the back portion, each of said at least one airflow passage containing at least one air inlet and at least one air outlet;
at least one heating element located within said at least one airflow passage;
at least one fan configured to direct air through said at least one air inlet into said at least one airflow passage, whereby the air passes in proximity to the at least one heating element and exits the at least one airflow passage through said at least one air outlet;
at least one movable member within said space; and
a plurality of light sources attached to said at least one movable member, each light source configured to vary in intensity as the at least one member moves such that the plurality of light sources generates an appearance of flames.

16. A method for controlling the simulated flame fireplace of claim 15, the method comprising:
turning on the simulated flame fireplace;
selecting the desired simulated flame;
selecting the desired operation time for the simulated flame;
selecting the desired heat output; and
selecting the desired operation time for the heat output.

17. The simulated flame fireplace of claim 15, wherein the movable member is a rotatable member.

18. The simulated flame fireplace of claim 17, further comprising a plurality of rotatable members and a plurality of axes, each axis serving as the axis of rotation for at least one rotatable member.

19. The simulated fireplace of claim 18, wherein at least two axes are not substantially parallel to each other.

20. The simulated flame fireplace of claim 15, wherein the plurality of light sources is a plurality of light emitting diodes.

21. The simulated flame fireplace of claim 15, wherein at least some of the plurality of light sources vary in intensity by turning on and off.

22. The simulated flame fireplace of claim 15, wherein the at least one movable member comprises at least one disc.

23. The simulated flame fireplace of claim 15, further comprising a plurality of movable members, at least two of which are of a substantially different size from each other.

24. The simulated flame fireplace of claim 15, further comprising a plurality of movable members, at least two of which are of a substantially different shape from each other.

25. The simulated flame fireplace of claim 15, wherein said one or more movable members and said plurality of light sources can be activated independently of said heating apparatus.

26. The simulated flame fireplace of claim 15, wherein said one or more movable members and said plurality of light sources can be configured to increase or decrease the size of the simulated flames in accordance with whether said heating apparatus is configured to output increasing or decreasing amounts of heat.

27. The simulated flame fireplace of claim 15, further comprising an actuator and blocking portion, wherein the actuator is configured to position the blocking portion so as to contact said at least one movable member and prevent further motion of said at least one movable member.

28. The simulated flame fireplace of claim 27, wherein the blocking portion is configured to prevent further motion of said at least one movable member when said at least one movable member has been deactivated.

29. A simulated flame fireplace comprising:
a fireplace housing defining an interior space;
a heating apparatus configured to expel the heated air from the fireplace housing;
at least one movable member within said interior space; and
a plurality of light sources attached to said movable member, each light source configured to vary in intensity as the at least one member moves such that the plurality of light sources generate an appearance of flames.

30. A method for controlling the simulated flame fireplace of claim 29, the method comprising:
turning on the simulated flame fireplace;
selecting the desired simulated flame;
selecting the desired operation time for the simulated flame;
selecting the desired heat output; and
selecting the desired operation time for the heat output.

31. The simulated flame fireplace of claim 29, wherein the movable member is a rotatable member.

32. The simulated flame fireplace of claim 31, further comprising a plurality of rotatable members and a plurality of axes, each axis serving as the axis of rotation for at least one rotatable member.

33. The simulated fireplace of claim 32, wherein at least two axes are not substantially parallel to each other.

34. The simulated flame fireplace of claim 29, wherein the plurality of light sources is a plurality of light emitting diodes.

35. The simulated flame fireplace of claim 29, wherein at least some of the plurality of light sources vary in intensity by turning on and off.

36. The simulated flame fireplace of claim 29, wherein the at least one movable member comprises at least one disc.

37. The simulated flame fireplace of claim 29, further comprising a plurality of movable members, at least two of which are of a substantially different size from each other.

38. The simulated flame fireplace of claim 29, further comprising a plurality of movable members, at least two of which are of a substantially different shape from each other.

39. The simulated flame fireplace of claim 29, wherein said one or more movable members and said plurality of light sources can be activated independently of said heating apparatus.

40. The simulated flame fireplace of claim 29, wherein said one or more movable members and said plurality of light sources can be configured to increase or decrease the size of the simulated flames in accordance with whether said heating apparatus is configured to output increasing or decreasing amounts of heat.

41. The simulated flame fireplace of claim 29, further comprising an actuator and blocking portion, wherein the actuator is configured to position the blocking portion so as to contact said at least one movable member and prevent further motion of said at least one movable member.

42. The simulated flame fireplace of claim 41, wherein the blocking portion is configured to prevent further motion of said at least one movable member when said at least one movable member has been deactivated.
